(19) United States
(12) Patent Application Publication
(10) Pub. No.: US 2025/0212175 A1
(43) Pub. Date: Jun. 26, 2025

(54) ENHANCED NOTIFICATION MANAGEMENT

(71) Applicant: T-MOBILE INNOVATIONS LLC, Overland Park, KS (US)

(72) Inventors: Anthony Yiu, Newcastle, WA (US); Xiatong Wan, Bellevue, WA (US)

(21) Appl. No.: 18/391,252

(22) Filed: Dec. 20, 2023

(51) Int. Cl. H04W 68/02; H04L 1/08

(52) U.S. Cl. CPC H04W 68/02; H04L 1/08

(57) ABSTRACT

Embodiments of the present disclosure are directed to systems and methods for enhanced provision of push notifications in a wireless telecommunication network. In response to a push notification server providing a push notification to an external push notification service, the push notification server is provided with an indication whether the notification was delivered to a target UE or not. Using the feedback, the push notification server may carry out one or more mitigating procedures, such as instructing the target UE to refresh its push token or re-attempt delivery, if the notification was not delivered to the UE.

### SUMMARY

The present disclosure is directed to improving the delivery of notifications in a telecommunication network, substantially as shown and/or described in connection with at least one of the Figures, and as set forth more completely in the claims.

According to various aspects of the technology, feedback is provided to push notification components in a telecommunication core network in order to increase the likelihood that a notification is delivered to a user equipment (UE). Notifications, whether push notifications or the delivery of call notifications, are traditionally treated as ‘best effort’ delivery; that is, a telecommunication network makes an effort to deliver notifications, but no guarantee is given that such notifications are delivered to (or displayed on) a UE. By adding new mechanisms and messaging to existing telecommunication network components, they can be enabled to provide feedback to regarding the delivery status of a notification, allowing re-delivery or other remedial efforts to be attempted in an effort to increase the likelihood that the notification is delivered to the UE.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2. illustrates an environment in which implementations of the present disclosure may be employed;

FIG. 3 depicts a call flow diagram of a method for synchronous notification services, in accordance with embodiments described herein; and

FIG. 4 depicts a flow diagram of a method for synchronous notification services, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a telecommunication network may provide notifications to connected UEs, regardless of whether the UE has specifically requested the notification. Such notifications may include push notifications and call notifications. A push notification is an alert or message sent from a server or backend application to a UE. Unlike traditional notifications that the user must actively check for or request, push notifications are ‘pushed’ to the UE, even if an app is not currently opened. A call notification is similar to a push notification in that an alert is ‘pushed’ to a UE to alert the UE that it is receiving an incoming call; like a more generic push notification, a call notification does not require a particular application (e.g., a phone application) to be open in order to deliver (and display) the notification to the UE.

Conventionally, notifications are delivered using a coordination between telecommunication components of a telecommunication core network and a public (external) push notification service (PNS). A push application server (PAS) communicates a notification to a push proxy component, which acknowledges receipt of the notification to the PAS. The push proxy is configured to interface with the external PNS, and forwards the notification to the external PNS. In some instances today, the external PNS may provide an indication to the push proxy component that an error exists and that the notification cannot be delivered to the target UE; however, even if that feedback is provided to the push proxy component-which does not always happen-conventional push proxies are not configured to provide feedback to the PAS. Absent this feedback, the PAS may assume it satisfied its ‘best effort’ attempt to deliver the notification and take no further action, meaning that the notification will never be delivered to the target UE.

Unlike conventional solutions, the present disclosure is directed systems and methods that include mechanisms and call flows that provide feedback to the PAS in a way that increases the likelihood that a ‘best effort’ notification is delivered and provides transparency about the delivery status of each notification. When feedback is provided from external PNS to the push proxy component, the push proxy component is configured to forward the feedback to the PAS. In some aspects, the feedback may include an indication that the target UE has a bad push token. In other aspects, the feedback may include an indication that the notification was not delivered, which could be due to the UE being disconnected from service (e.g., turned off, in airplane mode, or out of range of a radio access network (RAN)). In yet other aspects, the feedback may include an indication that the notification has been delivered (or displayed) on the UE. In the first two cases, by the PAS understanding that a notification delivery has failed, the PAS or other telecommunication components can implement one or more remedial procedures in order to increase the likelihood that the notification is delivered (e.g., updating a UE push token or attempting re-delivery at a later time).

Accordingly, a first aspect of the present disclosure is directed to a system for enhanced provision of notifications in a wireless telecommunication network. The system comprises a base station configured to wirelessly communicate a notification to a user equipment (UE). The system further comprises one or more computer processing components configured to communicate the notification to a push notification service. The one or more computer processing components are further configured to receive an indication that the notification was not received by the UE. The one or more computer processing components are further configured to perform one or more delivery mitigation procedures.

A second aspect of the present disclosure is directed to a method for enhanced provision of notifications in a wireless telecommunication network. The method comprises communicating a first notification to a push notification service for delivery to a first user equipment (UE). The method further comprises receiving, from the first UE, a first confirmation that the first notification was delivered to the first UE. The method further comprises communicating a second notification to the push notification service for delivery to a second UE. The method further comprises receiving an indication that the second notification was not received by the second UE. The method further comprises performing one or more delivery mitigation procedures.

Another aspect of the present disclosure is directed to a non-transitory computer readable media having instructions stored thereon that, when executed by one or more computer processing components, cause the one or more computer processing components to perform a method for enhanced provision of notifications in a wireless telecommunication network. The method comprises communicating a first notification to a push notification service for delivery to a first user equipment (UE). The method further comprises receiving, from the first UE, a first confirmation that the first notification was delivered to the first UE. The method further comprises communicating a second notification to the push notification service for delivery to a second UE. The method further comprises receiving an indication that the second notification was not received by the second UE. The method further comprises performing one or more delivery mitigation procedures.

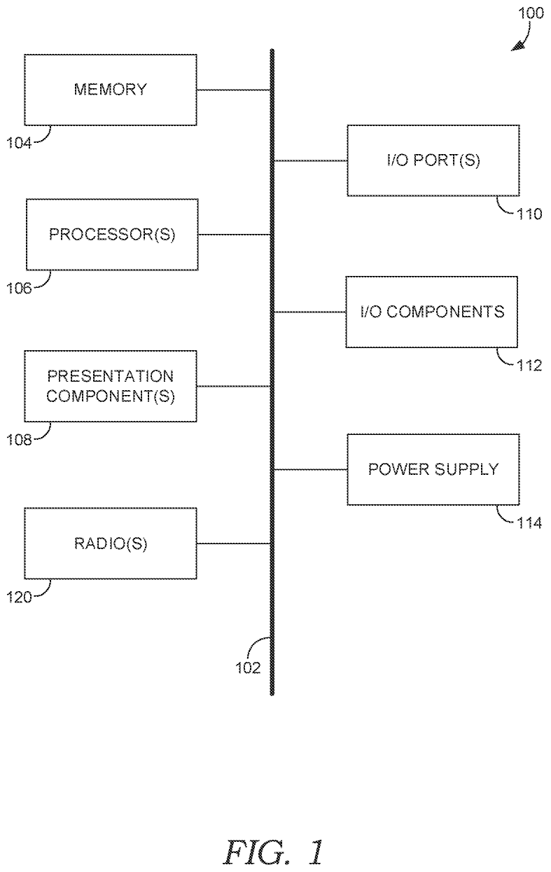

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VOLTE, or other VOIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

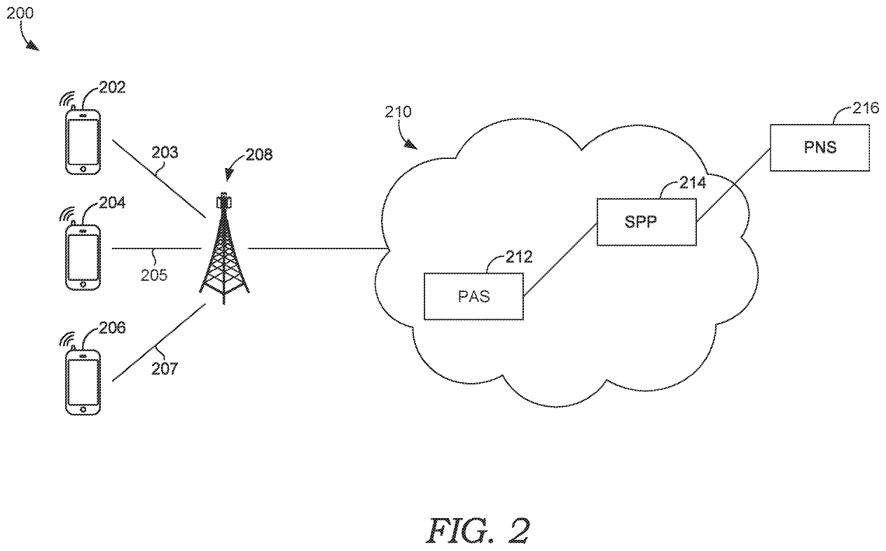

Turning now to FIG. 2, an exemplary network environment is illustrated in which implementations of the present disclosure may be employed. Such a network environment is illustrated and designated generally as network environment 200. At a high level the network environment 200 comprises a plurality of UEs, such as a first UE 202, a second UE 204, and a third UE 206, one or more base stations, and one or more networks. Though the plurality of UEs are illustrated as a cellular phone, a UE suitable for implementations with the present disclosure may be any computing device having any one or more aspects described with respect to FIG. 1. Each UE of the network environment 200 may, at times, be considered a mobile originating (MO) UE or a mobile terminating (MT) UE. A mobile originating UE refers to a UE that initiates a communication or action, whereas a mobile terminating UE refers to a UE that is the target of the communication of action. For example, if the first UE 202 initiates a voice call to the second UE 204, then the first UE 202 is the MO UE and the second UE is the MT UE. In aspects where a notification (e.g., a push notification) originates from an application server or telecommunication provider and is destined to the third UE 206, then the third UE 206 may also be considered an MT UE (or alternatively referred to as a “target UE”) for the purposes of the present disclosure. Similarly, though the one or more base stations are illustrated as macro cells on a cell tower, any scale or form of access point acting as a transceiver station for wirelessly communicating with a UE, including small cells, pico cells, and the like, are suitable for use with the present disclosure.

The network environment 200 comprises one or more base stations to which the UE 202 may potentially connect to (also referred to as ‘camping on’, ‘attaching’ in the industry).

Though the network environment 200 is illustrated with a single base station, one skilled in the art will appreciate that more base stations may be present in any particular network environment, including without limitation that each of the UEs are connected to different base stations. The base station 208 is configured to wirelessly communicate with UEs; for example, the bases station 208 may have a first wireless connection 203 with the first UE 202, a second wireless connection 205 with the second UE 204, and a third wireless connection 207 with the third UE 206. In aspects, any of the one or more base stations may communicate with a UE using any wireless telecommunication protocol desired by a network operator, including but not limited to 3G, 4G, 5G, 6G, 802.11x and the like. The base station 208 is configured to communicate with one or more UEs located within a geographical area. The geographical area for any particular base station may be referred to as the “coverage area” of the base station or simply the “cell,” as used interchangeably hereinafter. In some aspects, the coverage area for each particular base station is defined by an area in which signaling between a particular UE and the base station is usable for any purpose; in other aspects, the coverage area may be defined by mobile network operators. Generally, each base station of the one or more base stations may comprise one or more base transmitter stations, radios, antennas, antenna arrays, power amplifiers, transmitters/receivers, digital signal processors, control electronics, GPS equipment, and the like.

The base station 208 may be associated with one or more telecommunication networks (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations. For the purposes of illustrating the present disclosure, the base station 208 may be connected to a core network 210. The core network 210 may include multiple networks, as well as being a network of networks, but is shown in a more simple form so as to not obscure other aspects of the present disclosure.

The core network 210 suitable for use with the present disclosure comprises a push application server (PAS) 212 and a push proxy 214 such as a secure push proxy (SPP). The PAS 212 manages and facilities the delivery of push notifications to UEs that are connected to the base station 208 or other RAN nodes of the core network 210. The PAS 212 may, in some instances, be configured to generate notifications for delivery to a particular UE; in other instances, the PAS 212 may only be responsible for facilitating delivery of notifications generated by other components of the core network 210. Suitable notifications for use with the present disclosure include push notifications (e.g., messages or alerts) and call notifications (e.g., a voice over internet protocol (VOIP) call notification, voice over new radio (VoNR) call notification, or a voice over long term evolution (VOLTE) call notification). In order to deliver notifications to a target UE, the PAS 212 is configured to communicate with the push proxy 214. The push proxy 214 is configured to receive notifications from the PAS 212 and interface with one or more push notification services (e.g., Apple Push Notification Service (APNS), Firebase Cloud Messaging (FCM), Windows Notification Service (WNS), and Tizen Push Service (TPS)), collectively illustrated in network environment 200 as PNS 216. Though illustrated as discrete components, the present disclosure contemplates that the push proxy 214 may be unitary with the PAS 212, merely acting as an interface with the PNS 216.

The PAS 212 is generally configured to manage the delivery of the notifications to one or more UEs in the network environment 200. In some aspects, the PAS 212 may be configured to request a delivery confirmation for every notification communicated to the push proxy 214 and PNS 216, wherein the delivery confirmation indicates that the notification has been delivered to a target UE. In other aspects, the PAS 212 may be configured to selectively request said delivery confirmation; for example, delivery confirmation for notifications may be based on their origination from a particular source (e.g., emergency services vs. advertisers), a notification type (e.g., voice call notifications), or a notification priority. In the event that the PAS 212 requests a delivery confirmation as part of the notification and does not receive one, the PAS 212 may implement one or more mitigating procedures. If the PAS 212 receives an indication that a notification has failed to be delivered to the second UE 204, the PAS 212 may instruct the second UE 204 to refresh or update its push token or other push notification credentials; said token refresh instructions may occur before or after a configurable number of delivery re-attempts. If the PAS 212 does not receive a delivery confirmation for a notification that was destined to the second UE 204, then the one or mitigating procedures may comprise attempting re-delivery of the notification for a configurable number of times (or until the second UE 204 confirms delivery). In yet other aspects, the one or more mitigating procedures may be implemented for delivery failure to the second UE 204 based on a determination that a second notification was successfully delivered to another UE, such as the third UE 206.

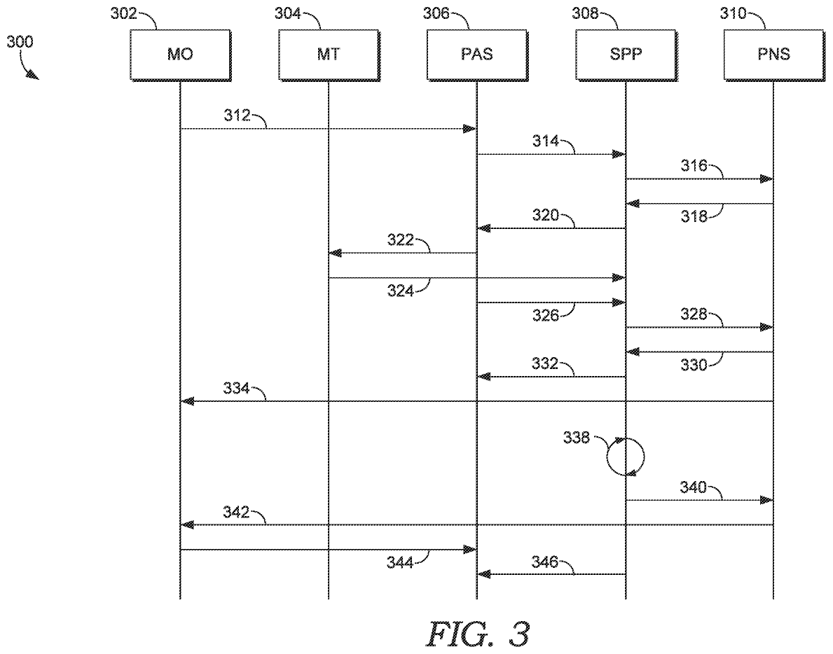

The network environment 200 may be utilized to implement new and/or improved call flows for use with providing synchronous feedback for push notification services, such as those illustrated in FIG. 3. Turning now to FIG. 3, a call flow 300 is presented for providing synchronous feedback for push notification services. The call flow 300 may comprise an MO 302 (e.g., the first UE 202 of FIG. 2), an MT 304 (e.g., the second UE 204 of FIG. 2), a PAS 306 (e.g., the PAS 212 of FIG. 2), a push proxy 308 (e.g., the push proxy 214 of FIG. 2), and a PNS 310 (e.g., the PNS 216 of FIG. 2). In aspects where the call flow 300 is a voice call, the call flow 300 begins with a first step 312, wherein the MO 302 originates a voice call to the MT 304. In aspects where the call flow 300 is a non-voice push notification, the first step 312 may not take place, as the push notification may originate from a source other than the MO (e.g., an application server, telecommunication network component, or the like). In a second step 314, the PAS communicates a notification to the SPP 308, wherein the notification is a push notification or a voice call notification. At a third step 316, the notification is communicated from the SPP 308 to the PNS 310. Under ideal circumstances, the communication of the notification to the PNS 310 at step 316 would result in the notification being sent to a target UE such as the MT UE 304; however, if the PNS 310 detects or determines an error with the notification, it will communicate the error message to the SPP 308.

In the event that an error message is communicated to the SPP 308 at a fourth step 318, a mitigation procedure will be initiated. In such a circumstance, the SPP 308 will communicate the notification error to the PAS 306 at a fifth step 320, which may cause the PAS 306 to instruct the MT UE 304 to refresh its push token at a sixth step 322. After the MT UE 304 refreshes its push token at a seventh step 324, the PAS 306 re-attempts the notification delivery process by re-communicating the notification to the SPP 308 at an eighth step 326. The SPP 308 once again communicates the notification to the PNS 310 at a ninth step 328. At a tenth step 330, the PNS 310 communicates an acknowledgement to the SPP 308 that the notification has been successfully queued for delivery to the MT UE 304. At an eleventh step 332, the SPP 308 closes the loop with the PAS 306 that the notification has been successfully queued at the PNS 310.

The call flow 300 also comprises a delivery confirmation procedure. Whether because the mitigation procedure described above was successful or because steps 318-328 do not occur because the communication of the notification at the third step 316 results in a successful acknowledgement at step 330, the call flow 300 may further comprise obtaining a delivery confirmation from the MT UE 304. Following the eleventh step 332, the PNS 310 attempts to deliver the notification to the MT UE 304 at a twelfth step 334. In some aspects, the notification includes an instruction to the MT UE 304 to confirm delivery, confirm display, or confirm user interaction with the notification. In one aspect, the MT UE 304 does not respond to the twelfth step 334, suggesting that the notification was not delivered to the MT UE 304 (e.g., because the MT UE 304 is powered off, in airplane mode, out of coverage, or the like). In such an aspect, the SPP 308 may perform a delivery mitigation procedure at a thirteenth step 338. At the thirteenth step 338, the SPP 308 may wait for a configurable amount of time before re-attempting the notification delivery process by again communicating the notification to the PNS 310 at a fourteenth step 340. In other aspects, at the thirteenth step 338, the SPP 308 may determine that the notification is a threshold high priority before re-attempting notification delivery by performing the fourteenth step 340. Once the PNS 310 receives the re-attempted notification, the PNS 310 again attempts delivery of the notification to the MT UE 304 at a fifteenth step 342. Once the MT UE 304 receives the notification, whether because of the twelfth step 334 or because of the re-attempted delivery at step 342 following the mitigation procedure, the MT UE 304 communicates a confirmation that the notification was delivered, displayed, or interacted with to the SPP 344 at a sixteenth step 344. In response to receiving a suitable confirmation from the MT UE 304, the SPP 308 communicates an indication to the PAS 306 at seventeenth step 346 that the notification was delivered, displayed, or interacted with. Though not illustrated by the call flow 300, the call flow may include a plurality of re-attempted notification deliveries (steps 334-342) until a threshold number of delivery attempts have been made to the MT UE 304. If the threshold number of delivery attempts have been made, then the call flow 300 would include a communication from the SPP 308 to the PAS 306 that the notification delivery failed. In sum, the PAS 306 is provided feedback about the notification delivery status regardless of whether notification delivery was successful or failed.

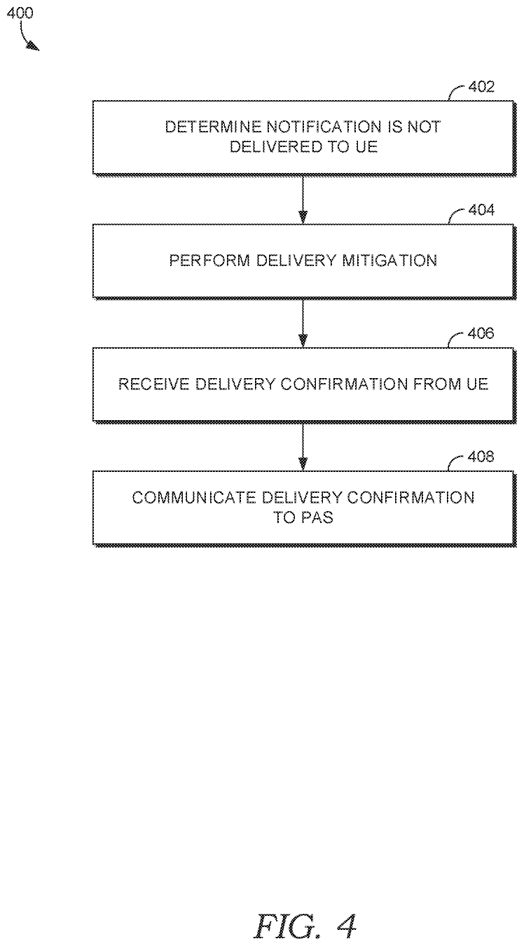

Turning now to FIG. 4, a flow chart representing a method 400 is provided. Generally, the method 400 increases the likelihood of notification delivery according to any one or more aspects described with respect to FIGS. 2-3. At a first step 402, a determination is made that a notification, such as a push notification or a voice call notification, was not delivered to a target or MT UE, according to any one or more aspects described with respect to FIGS. 2-3. At a second step 404, one or more delivery mitigation procedures are performed; as discussed according to any one or more aspects of FIGS. 2-3, the one or more delivery mitigation procedures may comprise instructing the target or MT UE to refresh a push token or to re-attempt delivery a threshold number of times. At a third step 406, a confirmation is received from the target or MT UE that the notification was delivered, displayed, or interacted with by a user-based on the confirmation requirements of the notification, according to any one or more aspects described with respect to FIGS. 2-3. At a fourth step 408, the notification confirmation is communicated to a push application server, such as the PAS 306 of FIG. 3 or the PAS 212 of FIG. 2, according to any one or more aspects of FIGS. 2-3.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for enhanced provision of notifications in a wireless telecommunication network, the system comprising:
a base station configured to wirelessly communicate a notification to a user equipment (UE); and
one or more computer processing components configured to perform operations comprising:
communicating the notification to a push notification service;
receiving an indication that the notification was not received by the UE; and
performing one or more delivery mitigation procedures.

2. The system of claim 1, wherein the notification comprises an instruction for the UE to communicate a delivery confirmation to the one or more computer processing components.

3. The system of claim 2, wherein the instruction for the UE to communicate the delivery confirmation includes a requirement that the notification be displayed on a user interface of the UE.

4. The system of claim 2, wherein the instruction for the UE to communicate the delivery confirmation includes a requirement that a user interacts with the notification.

5. The system of claim 2, wherein the notification is a push notification.

6. The system of claim 2, wherein the notification is a voice call notification.

7. The system of claim 6, wherein the one or more delivery mitigation procedures comprises instructing the UE to refresh its push token.

8. The system of claim 7, wherein the one or more delivery mitigation procedures further comprises re-attempting delivery of the notification to the UE a predetermined number of times prior to instructing the UE to refresh its push token.

9. The system of claim 5, wherein the one or more delivery mitigation procedures further comprises re-attempting delivery of the notification to the UE a predetermined number of times.

10. The system of claim 9, wherein the one or more mitigation procedures are performed in response to a determination that a second notification was successfully delivered to a second UE.

11. A method for enhanced provision of notifications in a wireless telecommunication network, the method comprising:
communicating a first notification to a push notification service for delivery to a first user equipment (UE);
receiving, from the first UE, a first confirmation that the first notification was delivered to the first UE;
communicating a second notification to the push notification service for delivery to a second UE;
receiving an indication that the second notification was not received by the second UE; and
performing one or more delivery mitigation procedures.

12. The method of claim 11, wherein the notification is a push notification.

13. The method of claim 12, wherein the one or more delivery mitigation procedures further comprises re-attempting delivery of the notification to the UE a predetermined number of times.

14. The method of claim 11, wherein the notification is a voice call notification.

15. The method of claim 11, wherein the one or more delivery mitigation procedures comprises instructing the UE to refresh its push token.

16. A non-transitory computer readable media having instructions stored thereon that, when executed by one or more computer processing components, cause the one or more computer processing components to perform a method for enhanced provision of notifications in a wireless telecommunication network, the method comprising:
communicating a first notification to a push notification service for delivery to a first user equipment (UE);
receiving, from the first UE, a first confirmation that the first notification was delivered to the first UE;
communicating a second notification to the push notification service for delivery to a second UE;
receiving an indication that the second notification was not received by the second UE; and
performing one or more delivery mitigation procedures.

17. The non-transitory computer readable media of claim 16, wherein the notification is a push notification.

18. The non-transitory computer readable media of claim 17, wherein the one or more delivery mitigation procedures further comprises re-attempting delivery of the notification to the UE a predetermined number of times.

19. The non-transitory computer readable media of claim 16, wherein the notification is a voice call notification.

20. The non-transitory computer readable media of claim 19, wherein the one or more delivery mitigation procedures comprises instructing the UE to refresh its push token.
